(19) United States
(12) Patent Application Publication
(10) Pub. No.: US 2003/0090768 A1
(43) Pub. Date: May 15, 2003

(54) Long haul optical communication system

(76) Inventors: Xiang Liu, Eatontown, NJ (US); Xing Wei, New Providence, NJ (US); Chunhui Xu, Piscataway, NJ (US)

Correspondence Address: Docket Administrator (Room 3J-219), Lucent Technologies Inc., 101 Crawfords Corner Road, Holmdel, NJ, 07733-3030, US

(21) Appl. No.: 09/990,965

(22) Filed: Nov. 21, 2001

Related U.S. Application Data
(60) Provisional application No. 60/309,359, filed on Aug. 1, 2001.

(51) Int. Cl. H04B 10/04

(52) U.S. Cl. 359/183; 359/180

(57) ABSTRACT

A high bit rate, long haul optical communication system encodes a polarization interleaved stream of RZ optical pulses using phase shift keying (PSK) or differential phase shift keying (DPSK), in contrast to conventional on-off keying (OOK). The polarization interleaved stream of RZ optical pulses can be used for PSK or DPSK encoding of either one data stream having a bit rate that is the same as the optical stream pulse rate, or two (or more) independent data streams which individually each have lower bit rates, but which, when combined, have the same rate as the optical stream pulse rate. The latter arrangement essentially accomplishes polarization multiplexing (P-MUX). Individual wavelengths can be combined in a WDM or DWDM system, wherein, at the transmitter, multiple streams of polarization interleaved pulses, each stream having a different wavelength, are combined. At the receiver, the received combined signal is wavelength division demultiplexed, and the encoded data in each wavelength channel is recovered by a PSK or DPSK receiver, which, in the DPSK example, usually consists of a delay demodulator and a balanced detector. The transmission medium and laser power may be managed, for example so that the pulse transmission comprises solitons.

### CROSS-REFERENCE TO RELATED APPLICATION

This application claims priority of Provisional Application Serial No. 60/309,359 which was filed Aug. 1, 2001.

### TECHNICAL FIELD

The present invention relates to optical communications, and more particularly to a long haul optical communication system, including a WDM system, using phase shift keying (PSK) or differential phase shift keying (DPSK) of return to zero (RZ) optical pulses in conjunction with polarization multiplexing or polarization interleaving.

### BACKGROUND OF THE INVENTION

Development of high bit rate (e.g., 40 Gbit/s) optical transmission systems have been hampered by intra-channel non-linear penalties, such as intra-channel cross phase modulation (XPM) among adjacent overlapping bits that mostly leads to timing jitter, as well as by intra-channel four wave mixing (FWM), that mostly leads to amplitude fluctuations. Use of high bit rates in conjunction with long haul and ultra-long haul (ULH) transmission, particularly in the environment in which multiple channels are combined in a WDM or DWDM system, has been additionally difficult, due to both the worsened nonlinear impairments and the increased amplifier spontaneous emission (ASE) noise, which leads to degradation of pulses as they propagate through an optical fiber path from a transmitter to a receiver, and various undesirable inter-channel effects, such as inter-channel XPM and FWM.

While various techniques have been attempted to reduce or eliminate the effects of noise and fiber nonlinearity, these techniques have had varying degrees of success. Some techniques have proven useful in single wavelength channel systems, but do not work well in the context of WDM systems, in which many different wavelengths are combined in a single optical transmission medium. Other techniques have used various combinations of dispersion management in the optical communication medium as well as different coding techniques in the transmitter and receiver. However, until now, no solution has proved effective in the environment of long (or ultra long) haul transmission of multiple WDM channels, on a cost effective basis.

### SUMMARY OF THE INVENTION

In accordance with the present invention, a high bit rate, long haul optical communication system encodes a polarization interleaved stream of RZ optical pulses using phase shift keying (PSK) or differential phase shift keying (DPSK), in contrast to conventional on-off keying (OOK). Because adjacent bits are orthogonally polarized, FWM among these adjacent bits is advantageously greatly weakened due to fiber birefringence, which quickly breaks the phase matching condition required for efficient FWM. The orthogonality of the polarization states between adjacent bits can be well maintained over long distance in the PSK or DPSK arrangement, effectively suppressing the FWM of the adjacent bits along the entire transmission. This is enabled by the fact that, unlike in OOK systems, the degree of polarization (DOP) of each polarization state is maintained even in the presence of the nonlinear polarization rotation induced from XPM and polarization-mode-dispersion (PMD), since the polarization rotation of each bit has no pattern dependence in a PSK or a DPSK system.

In accordance with another aspect of the present invention, the polarization interleaved stream of RZ optical pulses can be used for PSK or DPSK encoding of either one data stream having a bit rate that is the same as the optical stream pulse rate, or two (or more) independent data streams which individually each have lower bit rates, but which, when combined, have the same rate as the optical stream pulse rate. The latter arrangement essentially accomplishes polarization multiplexing (P-MUX).

Also in accordance with the present invention, individual wavelengths can be combined in a WDM or DWDM system. At the transmitter, multiple streams of polarization interleaved pulses, each stream having a different wavelength, are combined. At the receiver, the received combined signal is wavelength division demultiplexed, and the encoded data in each wavelength channel is recovered by a PSK or DPSK receiver, which, in the DPSK example, usually consists of a delay demodulator and a balanced detector. The transmission medium and laser power may be managed, for example so that the pulse transmission comprises solitons.

In the past, it was thought that nonlinear polarization rotation due to polarization mode dispersion (PMD) and inter-channel XPM would cause rapid and random polarization fluctuations in the WDM channels, making error-free polarization demultiplexing impossible. We have found that by doing phase coding only (e.g., DPSK), the amount of nonlinear polarization rotation becomes constant and deterministic, and therefore, can be compensated. Thus, phase coding allows the use of PDM, opening a new dimension to increase the system capacity.

The present invention thus enables significant reduction of nonlinear penalties, especially in high-bit-rate RZ transmissions where adjacent bits tend to overlap each other. The penalties due to inter- and intra-channel cross-phase-modulation (XPM) are essentially eliminated by use of PSK or DPSK, while the penalty due to intra-channel four-wave-mixing (FWM) is greatly reduced by polarization interleaving. Error-free transmission of over 6,000 km can be achieved with this arrangement using systems consisting of 100-GHz spaced polarization-interleaved 40 Gbit/s WDM channels and 100-km dispersion managed spans. Polarization scattering resulting from polarization-mode-dispersion (PMD) and XPM is also eliminated, making it possible for polarization demultiplexing that further increases system margins. Compared with polarization-multiplexed on-off-keying (OOK) RZ transmissions, DPSK RZ transmission offers˜3 dB improvement in system reach.

### BRIEF DESCRIPTION OF THE DRAWINGS

The present invention will be more fully appreciated by consideration of the following detailed description, which should be read in light of the drawing in which:

FIG. 1 is a block diagram of one embodiment of a high bit rate (e.g., 40 Gbit/s) long haul (or ultra long haul) optical communication system arranged in accordance with the principles of the present invention to encode a polarization interleaved stream of RZ optical pulses using phase shift keying (PSK) (or, optionally, differential phase shift keying (DPSK)), in contrast to conventional on-off keying (OOK);

FIGS. 2A and 2B are illustrations of the x-component and of the y-component of the electrical field present at the input of polarization combiner 111 of FIG. 1;

FIG. 3 is an illustration of the x-component and of the y-component of the electrical field present at the output of polarization combiner 111 of FIG. 1;

FIGS. 4A and 4B are illustrations representing the x-component and of the y-component, respectively, of the electrical field at the output of phase modulator 121 of FIG. 1; and

FIG. 5 is a block diagram of an alternative arrangement for the transmitter portion of a high bit rate long haul (or ultra long haul) optical communication system arranged in accordance with the present invention.

### DETAILED DESCRIPTION

The following acronyms are used in this application:

| | |
|---|---|
| ASE | amplifier spontaneous emission |
| ASK | amplitude shift keying |
| DMS | dispersion managed soliton |
| DPSK | differential phase shift keying |
| WDM | wavelength division multiplexing |
| FWM | four wave mixing |
| OOK | on-off keying |
| PMD | polarization mode dispersion |
| PSK | phase shift keying |
| QPSK | quadrature phase shift keying |
| SPM | self-phase modulation |
| ULH | ultra-long haul |
| XPM | cross phase modulation |

In considering the following detailed description, the disclosure contained in co-pending application entitled “Long Haul Transmission in a Dispersion Managed Optical Communication System” filed concurrently herewith of behalf of applicants Andrew R. Chraplyvy, Chris Xu, Xiang Liu, and Xing Wei, and assigned to the same assignee as the present invention, which disclosure is hereby incorporated by reference, should also be considered.

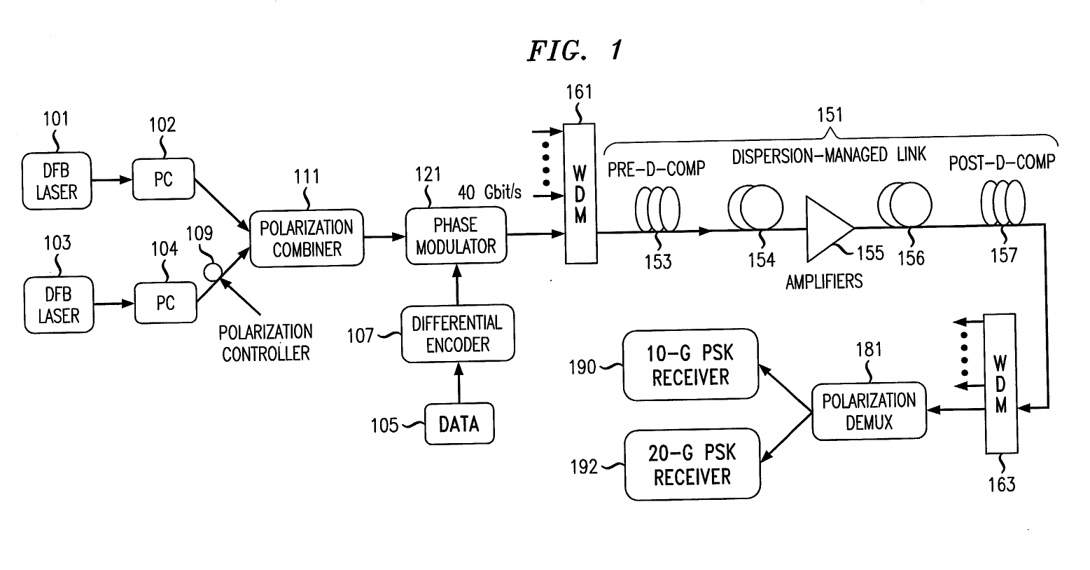

Referring now to FIG. 1, there is shown a block diagram of a high bit rate, long haul optical communication system arranged to encode a polarization interleaved stream of RZ optical pulses using phase shift keying (PSK) or, optionally, differential phase shift keying (DPSK), in contrast to conventional on-off keying (OOK). First and second distributed feedback lasers 101 and 103 are each connected to a respective pulse carver 102, 104, thereby forming, at the output of each pulse carver, a stream of RZ optical pulses, illustratively having a 20 GHz repetition rate and a nominal pulse duration of 8 ps. In order to arrange the respective outputs of pulse carvers 102 and 104 to be orthogonally polarized RZ pulse trains with respect to each other, one of the pulse trains (the output from pulse carver 104 in FIG. 1) is applied to a polarization controller 109, which is arranged to adjust the polarization so that the polarization of the two inputs to polarization combiner 111 are orthogonal to each other.. The pulse trains output from pulse carver 102 and polarization controller 109 are then combined in a polarization combiner 111. As an alternative, polarization maintaining fibers may connect pulse carvers 102 and 104 to polarization combiner 111 , with the fibers being arranged to include a 90 degree twist in one fiber with respect to the other.

Data to be encoded is available from a data source 105, and may optionally be differentially encoded in an optional differential encoder 107, such that, at the output of encoder 107, each transition (either from “0” to “1” or from “1” to “0”) corresponds to a digital “0” in the original data stream and each non-transition (a bit remains the same as the previous bit) corresponds to a digital “1” in the original data stream, or vice-versa. In either event, the data is assumed to have a data rate that is the same as the rate of the optical pulses output from polarization combiner 111.

The output of differential encoder 107 (or the data from data source 105, if differential encoding is not used) is applied to one input of a phase modulator 121, the other input of which is the polarization interleaved pulse stream output from combiner 111. The differential data (or the data directly, if differential encoding is not used) is used to code the phases of the optical pulses in such a way that “0s” are represented by a π-phase shift and “1s” by a 0-phase shift (or vice versa).

The output of phase modulator 121, which typically represents one channel or wavelength in a WDM system, is then combined with other WDM channels having different wavelengths, in a WDM multiplexer 161, before being applied to an optical communication medium, shown generally as 151, which may comprise a dispersion-managed optical fiber link. More specifically, optical communication medium 151 may include a pre-dispersion compensator 153, dispersion-compensated (not necessarily fully compensated) spans 154, 156, amplifiers such as amplifier 155, and a post-dispersion compensator 157.

After transmission, the WDM channels are separated or demultiplexed, in a WDM demultiplexer 163, and each individual one of the two 20 Gbit/s polarization interleaved bitstreams can, if desired, be recovered using a polarization demultiplexer (P-DMUX) 181 . Each individual bitstream is then applied to an individual PSK (or DSPK) receiver 190, 192, in order to extract the data contained therein. As an alternative, if P-DMUX 181 is not used, the received polarization interleaved signal can be applied to an optional PMD compensator and then to a single 40 Gbit/sec PSK (or DPSK) receiver, which again can recover the original data, which will, in this embodiment, be represented as a single bit stream.

In the arrangement of FIG. 1, PSK (or DPSK) receivers 190 and 192 may be realized by many means. For example, in a DPSK system, the receivers include a MZ interferometer and a balanced receiver arranged as described in M. Rohde, C. Caspar, N. Heimes, M. Konitzer, E.-J. Bachus, and N. Hanik, “Robustness of DPSK direct detection transmission format in standard fibre WDM systems,” Electon. Lett., vol. 36, pp. 1483-1484, 2000.

In one specific implementation of numerical simulation of the arrangement of FIG. 1, dispersion managed link 151 consisted of 100-km TW™ (Lucent) fiber spans with D=4 ps/km/nm and 4-km of dispersion-compensating fiber (DCF) which gives a residue span dispersion ranging from 0 to 15 ps/nm. The pre-dispersion compensation value is −200 ps/nm, and the post-dispersion compensation is such that the net dispersion of the whole system is zero. The path-averaged power per channel is −4 dBm (this is found to give nearly optimum performance). The span fiber loss is 21 dB, and is compensated by distributed Raman amplification with 50% forward and 50% backward Raman pumps. The ASE noise (NF=3.5 dB) is added after each span. PMD is simulated by a course step method as described by S. G. Evangelides, L. F. Mollenauer, J. P. Gordon, and N. S. Bergano, “Polarization multiplexing with solitons,” IEEE J. Lightwave Tech., vol. 10, pp. 28-35, 1992 and by D. Marcuse, C. R. Menyuk, and P. K. A. Wai, “Application of the Manakov-PMD equation to studies of signal propagation in optical fibers with randomly varying birefringence,” IEEE J. Lightwave Tech., vol. 15, pp. 1735-1746, 1997, with the PMD parameter chosen to be 0.1 ps/\sqrt{km}. After transmission, the channels are demultiplexed by an 85-GHz 4^{th}-order Gaussian filter, followed by PMD compensation in compensator 171.

The fact that the DOP of each of the two polarization states and their orthogonality are well maintained leads to two important benefits. First, the nonlinear effects such as XPM and intra-channel FWM are effectively reduced along the entire transmission. Second, P-DMUX can be applied due to the maintained high polarization extinction ratio. The use of P-DMUX reduces the bite rate to 20 Gbit/s, largely increasing the receiver tolerance to PMD and imperfect post dispersion compensation. The cost of the P-DMUX may be offset by the removal of PMD compensator and dynamic dispersion compensator. For example, PMD compensation is required after ˜1,000 km transmission with 40 Gbit/s data and 0.1 ps/\sqrt{km} PMD, while with the 20 Gbit/s data obtained after P-DMUX, PMD compensation may not be needed until 4,000 km.

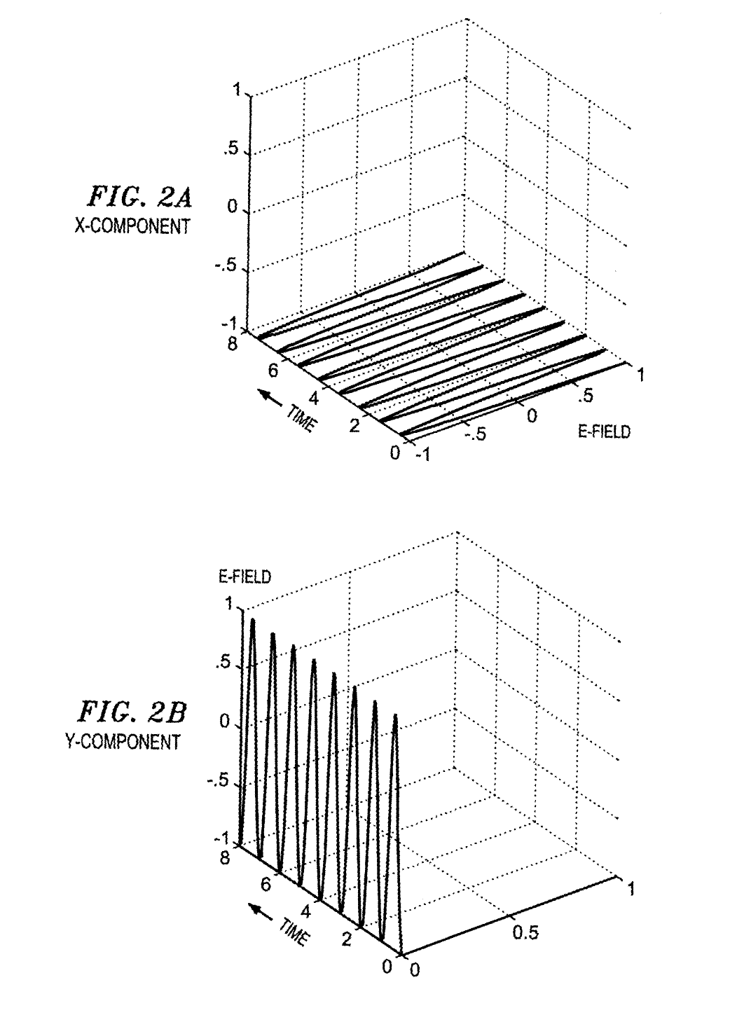

Referring now to FIG. 2, there is shown an illustration of the x-component and of the y-component of the electrical field present at the intput of polarization combiner 111 of FIG. 1. Both the x-component and the y-component are RZ signals, meaning that the electrical field varies between +1 and −1, passing through zero (0) during each bit interval. The x-component and the y-component are orthogonally polarized with respect to each other. Thus in FIG. 2(a), the x-component e field may, for illustration purposes, is depicted to lie in the plane of the paper, while the y-component e field is, for illustration purposes, depicted to lie in the vertical plane, which is perpendicular to the plane of the paper. Note that the timing of the x-component and the y-component are offset from each other by one-half bit interval by using an appropriate delay line, so that the pulses, when combined, are indeed interleaved.

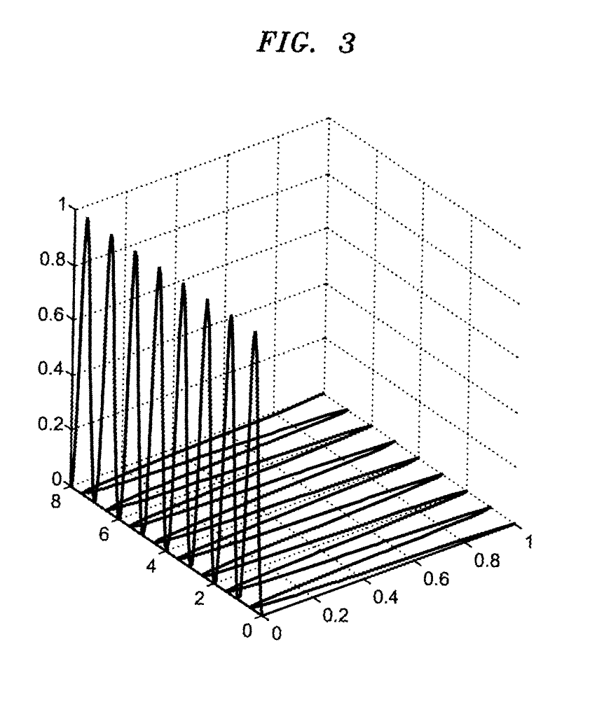

Referring now to FIG. 3, the electrical field of the combined signal at the output of polarization combiner 111 is shown. Again, it will be observed that (a) adjacent pulses have orthogonal polarization, and (b) the pulses are RZ in nature.

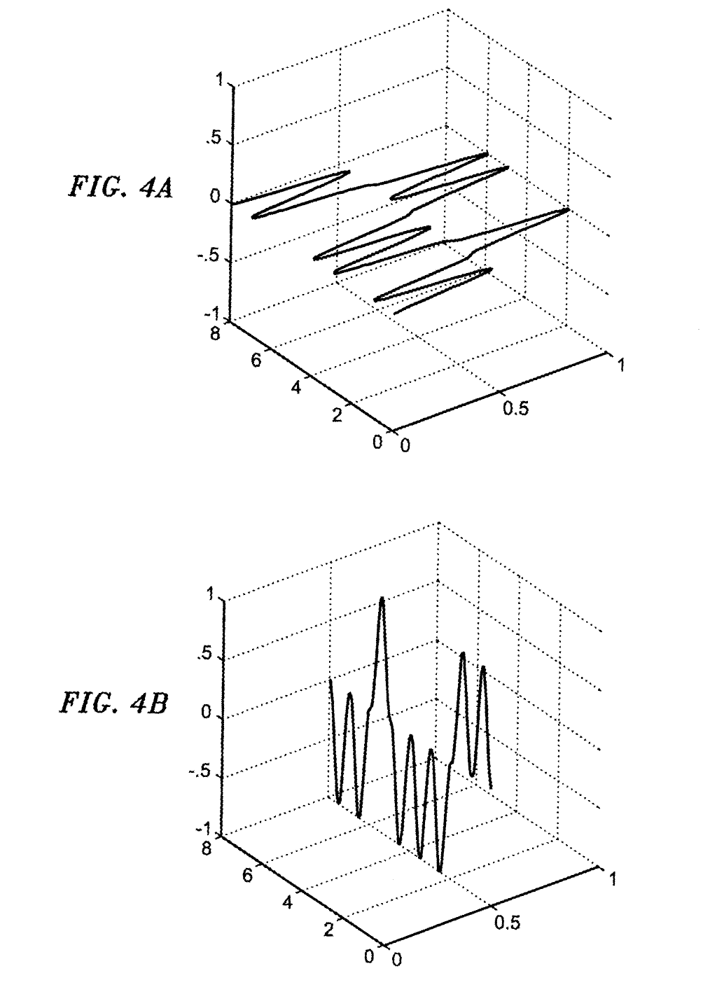

FIG. 4 is a graphical illustration of the output of phase modulator 121 of FIG. 1, when a sample stream of data is PSK encoded. For the purposes of illustration, the sample stream is:

01011000001110000

It is first to be again noted that this data stream is assumed to have the same bit rate as the pulse rate output from polarization combiner 111. Accordingly, a first set of alternate bits in the data stream encode the phase of pulses have a first polarization, and a second set of alternate bits (the remaining bits) encode the phase of pulses having the second, orthogonal polarization.

Still using the sample stream above as an example, the first and second sets of alternate bits can be derived as shown in the following table:

| | | | | | | | | | | | | | | | | | |
|---|---|---|---|---|---|---|---|---|---|---|---|---|---|---|---|---|---|
| Sample stream | 0 | 1 | 0 | 1 | 1 | 0 | 0 | 0 | 0 | 0 | 1 | 1 | 1 | 0 | 0 | 0 | 0 |
| First set | 0 | | 0 | | 1 | | 0 | | 0 | | 1 | | 1 | | 0 | | 0 |
| Second set | | 1 | | 1 | | 0 | | 0 | | 0 | | 1 | | 0 | | 0 | |

Referring now to FIG. 4, the upper portion of the figure shows that the x-component is encoded with the first set of bits, while the lower portion of the figure shows that the y-component is encoded with the second set of bits. In each figure, the time axis proceeds from a point nearest the reader, and continues in the direction generally to the left, which is away from the reader. The signal actually transmitted at the output of phase modulator 121 of FIG. 1 is the combination of the two signals shown in FIG. 4.

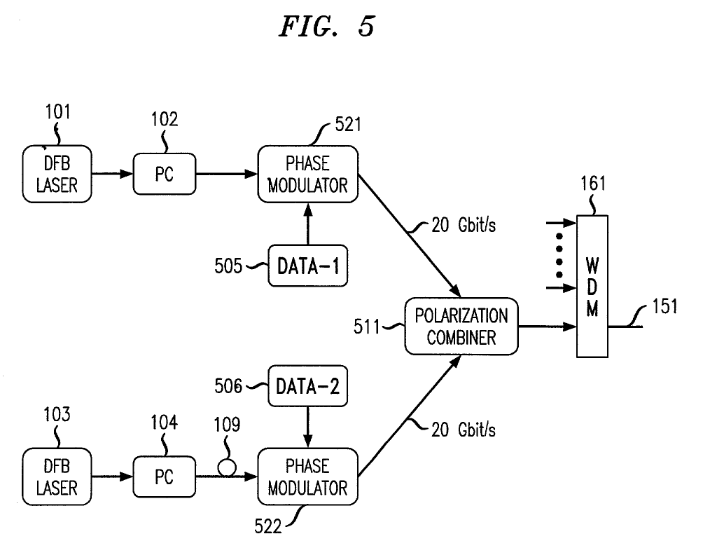

FIG. 5 illustrates a modification to the transmitter portion of FIG. 1, which accomplishes phase modulation of each polarization component before the components are combined. As in FIG. 1, two streams of RZ optical pulses are formed (a) by laser 101 and pulse carver 102, and (b) by laser 103 and pulse carver 104. The latter is appropriately delayed and polarization-controlled, so that the polarizations of the two pulse streams is orthogonal. The first (undelayed) pulse stream is applied to a first phase modulator 521, which modulates the phase of that stream in accordance with data from source 505. Likewise, the second (delayed) pulse stream is applied to a second phase modulator 522, which modulates the phase of that stream in accordance with data from a separate source 506. The outputs of both modulators 521 and 522 are then combined in a polarization combiner 511 before being applied to transmission medium 151 via WDM multiplexer 161.

From the foregoing, it is seen that in a PDM DWDM system, there are two data channels polarization muxed at each WDM wavelength. Thus, the system capacity is increased by a factor of 2 without reducing the WDM channel spacing. At the transmitter, the two channels have orthogonal polarizations, and if the degree of polarization is maintained throughout the transmission, polarization demultiplexing can be performed at the receiving end.

We now consider, for example, a DWDM DMS system, in which the solitons in different channels may overtake each other. Every time the soliton pulses pass each other, a soliton collision occurs and so does inter-channel XPM and nonlinear polarization rotation. Although nonlinear polarization rotation during the soliton collision does not occur if the polarizations of the two solitons are either parallel or perpendicular to each other, the presence of PMD in any fiber systems quickly destroys the initial polarization alignment of different wavelength channels, making nonlinear polarization rotation inevitable in any DWDM systems. In an OOK DWDM DMS system, each WDM channel has very different bit sequences, causing the solitons to experience very different collision patterns. This causes non-uniform polarization rotation within a single channel. In fact, it has been shown that the polarization fluctuation is random and rapid (on a bit-to-bit time scale). See, for example, B. C. Collings and L. Boivin, IEEE PHOTON. TECHNOL. LETT. 12, 1582-1584 (2000); and L. F. Mollenauer, J. P. Gordon, and P. Mamyshev, in Optical fiber telecommunications III; Vol. A, edited by I. P. Kaminow and T. L. Koch (Academic Press, San Diego, 1997), p. 373-460. Thus, it is not soliton collision itself but soliton collision with a random bit stream that results in the dramatic reduction of the degree of polarization within a single channel.

In a non-DMS RZ system, the pulses in each WDM channel are typically strongly dispersed, therefore, the pulses are now strongly overlapped. Such an overlap introduces XPM effects, which, in a random bit stream, results in the dramatic reduction of the degree of polarization within a single channel. Similar to the analysis in DMS, the combined effects of PMD, intra- (in non-DMS) or inter- (in DMS) channel XPM (nonlinear polarization rotation) significantly limit the applicability of PDM in any ULH DWDM OOK system. In fact, both numerical simulations and experimental results have shown that PDM fails in an ULH DWDM OOK system. We realized the fact that XPM depends only on the intensity profile of the pulses and is independent of the phases of the pulses (in contrast to FWM). Hence, by doing phase coding only, one is able to eliminate the impairment caused by XPM.

Advantageously, in a PSK DMS system that is arranged to implement the present invention, data is encoded in the phase of the soliton, i.e., “0”=−1 (pi phase shift) and “1”=1 (0 phase shift). The collisions between solitons in different WDM channels still occur. However, since each WDM channel has identical, uniform intensity pattern, the collisions are the same for all solitons. The net effects of the collisions are uniform rotation of polarization states. Thus, the degree of polarization is well maintained.

Similar analysis applies to a non-DMS system. In this case, the pulse pattern within the same WDM channel is uniform. Thus, pattern depedent intra-channel XPM effects are eliminated. Because the inter-channel XPM effects in a non-DMS RZ system are typically small, the degree of polarization of the non-DMS RZ system is well maintained.

Although our simulations were performed for 10G and 40G systems with specific fiber types and dispersion map, PDM DPSK-DMS can also be applied to other bit-rate systems with many different fiber types and dispersion maps. For example, PDM 40 Gbit/s DWDM systems with DPSK provide the potential to achieve a SE of 0.8 while maintaining the system reach of the current 40 Gbit/s systems. PSK-PDM can also be combined with multi-level coding sckeme, such as QPSK, to further increase the system capacity.

While in the previous description, the present invention was applied in the context of a high bit rate system, it is to be understood that a PSK-PDM technique as described above can also be used with systems with a variety of different bit-rates, as well as with many different fiber types and dispersion maps. For example, satisfactory performance can also be obtained with standard single mode fiber.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

I/we claim:

1. A transmitter for use in an optical communication system, said transmitter comprising
means for generating a stream of RZ optical pulses in which alternate ones of such pulses have essentially orthogonal polarizations, and
means for modulating the phase of said optical pulses as a function of input data applied to said transmitter.

2. The invention defined in claim 1 wherein said modulating means is a phase shift keyed (PSK) modulator.

3. The invention defined in claim 1 wherein said modulating means is arranged to modulate said optical pulses in accordance with the differences between successive bits in said input data.

4. A transmitter for use in an optical communication system, said transmitter comprising
means for generating first and second streams of RZ optical pulses in which pulses is said first stream have essentially orthogonal polarizations with respect to pulses in said second stream, and
means for modulating the phase of said optical pulses in said first and second streams as a function of first and second streams of input data applied to said transmitter, respectively.

5. The invention defined in claim 4, wherein said first and second streams of optical pulses each have the same first wavelength, and wherein said transmitter further includes a wavelength division multiplexer for combining the output of said modulation means with at least a second modulated optical signal having a wavelength different from said first wavelength.

6. The invention defined in claim 4 wherein said optical pulses are solitons.

7. An optical communication system arranged to transmit at least one stream of input data from a transmitter to a remote receiver, said system comprising
a transmitter for generating a stream of Rz optical pulses in which alternate ones of such pulses have essentially orthogonal polarizations, and for modulating the phase of said optical pulses as a function of said input data applied to said transmitter, and
an optical communication channel for transmitting the modulated optical pulses from said transmitter to said remote receiver.

8. The invention defined in claim 7 wherein said system further includes a demodulator for recovering said at least one stream of input data from said modulated optical pulses received at said remote receiver.

9. A method for transmitting input data using an optical communication system, said method comprising the steps of
generating a stream of RZ optical pulses in which alternate ones of such pulses have essentially orthogonal polarizations, and
modulating the phase of said optical pulses as a function of said input data.

10. The method defined in claim 9 wherein said modulating step includes phase shift keying of said optical pulses in a PSK modulator.

11. The invention defined in claim 9 wherein said modulating step includes modulating said optical pulses in accordance with the differences between successive bits in said input data.

12. A method for transmitting input data using an optical communication system, said method comprising the steps of
generating first and second streams of RZ optical pulses in which pulses is said first stream have essentially orthogonal polarizations with respect to pulses in said second stream, and
modulating the phase of said optical pulses in said first and second streams as a function of first and second streams of input data, respectively.

13. The method defined in claim 12, wherein said first and second streams of optical pulses each have the same first wavelength, and wherein said method further includes the step of combining, in a wavelength division multiplexer, the phase modulated optical pulses generated in said modulation step with at least a second modulated optical signal having a wavelength different from said first wavelength.

14. The invention defined in claim 12 wherein said optical pulses are solitons.

15. An optical communication method for transmitting at least one stream of input data from a transmitter to a remote receiver, said method comprising the steps of
generating a stream of RZ optical pulses in which alternate ones of such pulses have essentially orthogonal polarizations, and modulating the phase of said optical pulses as a function of said input data applied to said transmitter, and
transmitting the modulated optical pulses from said transmitter to said remote receiver via an optical communication channel.

16. The invention defined in claim 15 wherein said method further includes demodulating said modulated optical pulses received at said remote receiver to recover said at least one stream of input data.
